(19) United States
(12) Patent Application Publication
(10) Pub. No.: US 2007/0035248 A1
(43) Pub. Date: Feb. 15, 2007

(54) Plasma display panel

(75) Inventors: Kyung Wha Lee, Seoul (KR); Jae Sang Chung, Seongnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/501,707

(22) Filed: Aug. 10, 2006

(30) Foreign Application Priority Data
Aug. 11, 2005 (KR) 10-2005-0073549

(51) Int. Cl. H01J 17/49

(52) U.S. Cl. 313/587

(57) ABSTRACT

A plasma display panel is disclosed. The plasma display panel includes a maintenance electrode pair formed on an upper part of a front panel, a dielectric layer for covering the maintenance electrode pair, a protective layer formed on an upper part of the dielectric layer, and a rear panel separated from the front panel by a given distance. The protective layer includes F center and F+ center.

This Nonprovisional application claims priority under 35 U.S.C. § 119(a) on Patent Application No. 10-2005-0073549 filed in Korea on Aug. 11, 2005 the entire contents of which are hereby incorporated by reference.

### BACKGROUND OF THE INVENTION

1. Field of the Invention

This document relates to a plasma display panel.

2. Description of the Background Art

A plasma display panel displays an image using a physical phenomenon of a gas discharge. The plasma display panel can be used in not only a display having a single digit but also a graphic display of the size of Im in a diagonal line having two million pixels. Accordingly, the plasma display panel is one of commercially successful displays.

When an image is displayed on the plasma display panel, a firing voltage is applied to an electrode formed inside the plasma display panel such that a plasma discharge occurs on a protective layer.

A magnitude of the firing voltage applied to the electrode is determined by a distance between discharge spaces formed between a front panel and a rear panel constituting the plasma display panel, a kind and a pressure of a discharge gas filled in the discharge space, a property of a dielectric layer, and a property of the protective layer.

When generating the plasma discharge, positive ions and electrons within the discharge space have two opposite polarities. Wall charges having two opposite polarities are accumulated on the surface of the protective layer.

Since the protective layer is an insulator with a high resistance, the wall charges are accumulated on the surface of the protective layer. A discharge is maintained at a voltage less than the firing voltage by the accumulated wall charges, thereby having a memory function.

Since the plasma display panel is driven at a voltage between the firing voltage and the discharge maintaining voltage, when a memory margin increases, the plasma display panel can be driven more stably. Accordingly, the protective layer greatly affects the firing voltage and the discharge maintaining voltage. In particular, a material used as the protective layer needs to have a low sputtering rate, a high secondary electron emission coefficient and high transmissivity.

### SUMMARY OF THE INVENTION

Accordingly, an object of the present invention is to solve at least the problems and disadvantages of the background art.

An embodiment of the present invention provides a plasma display panel capable of generating a plasma discharge at a low voltage by improving a characteristic of a secondary electron emission coefficient of a protective layer.

An embodiment of the present invention also provides a plasma display panel capable of improving a brightness characteristic when driving the plasma display panel.

In an aspect, there is provided a plasma display panel comprising a maintenance electrode pair formed on an upper part of a front panel, a dielectric layer for covering the maintenance electrode pair, a protective layer which comprises F center and F+ center and is formed on an upper part of the dielectric layer, and a rear panel separated from the front panel by a given distance.

Implementations may include one or more of the following features. For example, when the front panel is divided into an effective region and a ineffective region, the number of F-centers and the number of F+ centers in a first protective region of the protective layer corresponding to the effective region may be more than the number of F-centers and the number of F+ centers in a second protective region of the protective layer corresponding to the ineffective region.

The rear panel may comprise a barrier rib for forming a discharge cell, and the number of F-centers and the number of F+ centers in a first protective region of the protective layer corresponding to the discharge cell may be more than the number of F-centers and the number of F+ centers in a second protective region of the protective layer corresponding to the remaining region except the discharge cell.

The number of F-centers and the number of F+ centers in a first protective region of the protective layer corresponding to a discharge gap formed by the maintenance electrode pair may be more than the number of F-centers and the number of F+ centers in a second protective region of the protective layer corresponding to the remaining region except the discharge gap.

The discharge gap may be the largest distance between ends of the maintenance electrode pair in one discharge region.

The F and F+ centers may be formed within 3/10 of the total thickness of the protective layer.

The protective layer may be formed of magnesium oxide (MgO).

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates the structure of a plasma display panel according to an embodiment of the present invention;

FIG. 2 illustrates a distribution range of the F and F+ centers of the protective layer formed on a front panel in the plasma display panel according to the embodiment of the present invention;

FIG. 3 illustrates the distribution of the number of F− centers and the number of F+ centers in a portion of the protective layer corresponding to a discharge cell in the plasma display panel according to the embodiment of the present invention;

FIG. 4 illustrates the distribution of the number of F− centers and the number of F+ centers in the protective layer corresponding to a maintenance electrode pair including a scan electrode and a sustain electrode in the plasma display panel according to the embodiment of the present invention; and

FIG. 5 illustrates the distribution of the F and F+ centers in a total thickness of the protective layer in the plasma display panel according to the embodiment of the present invention.

### DETAILED DESCRIPTION OF PREFERRED EMBODIMENTS

Preferred embodiments of the present invention will be described in a more detailed manner with reference to the drawings.

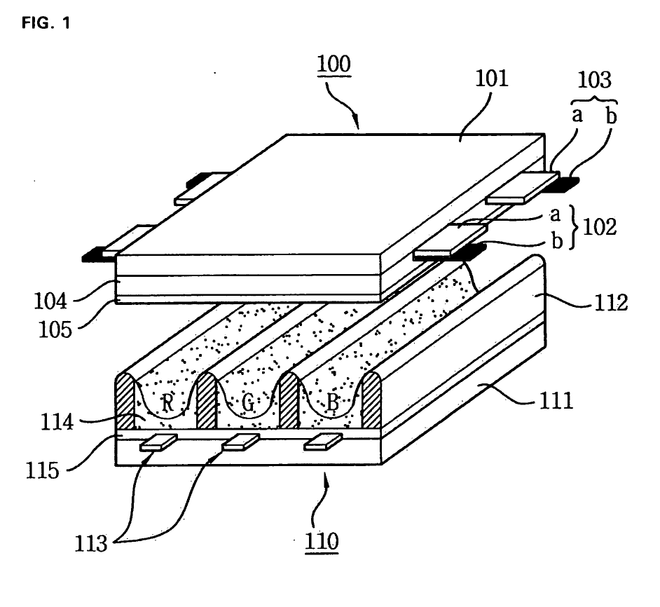

FIG. 1 illustrates the structure of a plasma display panel according to an embodiment of the present invention.

As illustrated in FIG. 1, the plasma display panel according to the embodiment of the present invention comprises a front panel 100 and a rear panel 110 which are coupled in parallel to oppose to each other at a given distance therebetween. The front panel 100 comprises a front substrate 101 which is a display surface. The rear panel 110 comprises a rear substrate 111 constituting a rear surface. A plurality of scan electrodes 102 and a plurality of sustain electrodes 103 are formed in pairs on the front substrate 101, on which an image is displayed, to form a plurality of maintenance electrode pairs. A plurality of address electrodes 113 are arranged on the rear substrate 111 to intersect with the plurality of maintenance electrode pairs.

The front substrate 101 or the rear substrate 111 of the plasma display panel is generally formed of a soda-lime based glass substrate. The soda-lime based glass substrate consists of SiO₂ of 70 weight %, Na₂O of 15 weight %, CaO of 10 weight %, and a small amount of Al₂O₃, K₂O and MgO.

The scan electrode 102 and the sustain electrode 103 generate a mutual discharge therebetween in one discharge cell and maintain emissions of discharge cells.

Since the maintenance electrode pair are disposed on a path of emitted light, it is preferable that the maintenance electrode pair comprise transparent electrodes 102a and 103a made of transparent indium-tin-oxide (ITO) material in consideration of transmissivity. The transparent electrodes 102a and 103a may be formed of indium oxide or tin oxide using a thin film forming method, a dipping method, a screen printing method, and the like.

Further, it is preferable that bus electrodes 102b and 103b formed of a conductive thin film such as Ag for compensating a high resistance of the transparent electrodes 102a and 103a are formed at edges of the maintenance electrode pair. The bus electrodes 102b and 103b is formed using a photo lithography method or is formed by printing a metal paste.

The scan electrode 102 and the sustain electrode 103 are covered with one or more upper dielectric layers 104 to limit a discharge current and to provide insulation between the maintenance electrode pairs.

The upper dielectric layers 104 may be formed using a screen printing method. The screen printing method is achieved by coating a dielectric paste and performing a dry process and firing process. The screen printing method is carried out using a simple production equipment and has a high material using efficiency. Further, the upper dielectric layers 104 may be formed in the form of a green sheet for making a dielectric layer in a film type. In such a case, uniformity of the upper dielectric layers 104 can be improved such that the plasma display panel can generate a stable discharge by reducing an erroneous discharge of the plasma display panel when driving the plasma display panel.

A protective layer 105 with a deposit of MgO is formed on an upper surface of the upper dielectric layer 104 to facilitate discharge conditions.

The protective layer 105 may be formed by vacuum depositing on the upper surface of the upper dielectric layer 104 using a sputtering method or an E-beam vacuum evaporation method. In such a case, it is preferable that the protective layer 105 may be formed of magnesium oxide (MgO) with a high secondary electron emission coefficient. Accordingly, when driving the plasma display panel, the discharge efficiency of the plasma display panel can increases.

The protective layer 105 may be formed of single crystal MgO or polycrystal MgO. The protective layer 105 may include a small amount of metal, metal oxide, silicon, and the like.

A plurality of stripe-type (or well-type) barrier ribs 112 are formed in parallel on the rear substrate 11 of the rear panel 110 to form a plurality of discharge spaces (i.e., a plurality of discharge cells).

The barrier rib 112 may be formed by alternately repeating a printing process and a drying process using a screen printing method. The barrier rib 112 may be formed using a screen mask method or a sand blast method. In such a case, it is preferable that a material of the barrier rib 112 uses a glass paste.

The plurality of address electrodes 113 for performing an address discharge to generate vacuum ultraviolet rays are arranged in parallel to the barrier ribs 112.

The address electrode 113 may be formed on the rear substrate 111 by thin-film depositing a metal material.

An upper surface of the rear substrate 111, i.e., the inside of the discharge cell formed by the barrier ribs 112 is coated with Red (R), green (G) and blue (B) phosphors 114 for emitting visible light for an image display when generating an address discharge.

A lower dielectric layer 115 is formed between the address electrodes 113 and the phosphors 114 to protect the address electrode 113.

The lower dielectric layer 115, in the same way as the upper dielectric layer 104, may be formed using a screen printing method or a green sheet.

The plasma display panel having the above-described structure is a kind of a surface discharge type AC plasma display panel.

The plasma display panel having the above-described structure generates a discharge and erases the discharge by applying a state (i.e., a wall voltage) of wall charges, which are accumulated on a wall surface of the upper dielectric layer of the front substrate by the maintenance electrode pair, to the address electrode of the rear substrate.

Since dielectric capacitance of the upper dielectric layer covering the maintenance electrode pair of the front panel is proportional to a dielectric constant of the upper dielectric layer, a high wall voltage is obtained by the upper dielectric layer with a high dielectric constant. Accordingly, the plasma display panel can generate the plasma discharge at a low maintenance voltage and a low driving voltage.

However, since the address electrode of the rear substrate sends an image signal to each of the discharge cells within the plasma display panel, it is preferable that the lower dielectric layer with a low dielectric constant for forming a low wall voltage is formed on the rear substrate. This reason is that quick light-emission and erasure of a discharge within each of the discharge cells of the plasma display panel are advantageous to an image display of the plasma display panel.

Accordingly, it is preferable that a material of the dielectric layer uses metal compound or glass doped with metal compound, and the like.

Each of the discharge cells by formed the barrier rib 112 is filled with a discharge gas. The discharge gas may use neon (Ne) or xenon (Xe) or a mixture of Ne and Xe.

In the plasma display panel having the above-described structure, the protective layer deposited on the upper surface of the dielectric layer comprises F center and F+ center.

The F and F+ centers are a point-shaped lattice defect having an electron or an aggregate of the point-shaped lattice defects. In other words, the F and F+ centers are a state for capturing an electron in a space lattice point of a negative ion. For example, the F and F+ centers are F and F+ centers of alkali halides. The F and F+ centers can be made by maintaining a single crystal of alkali halides at a high temperature inside a steam of a alkali metal.

The secondary electron is generated by exciting an electron from a valence band to a conduction band among an energy level of MgO of the protective layer. Accordingly, energy corresponding to a gap between the valence band and the conduction band is required to generate the secondary electron. Since the MgO protective layer according to the embodiment of the present invention comprises the F and F+ centers having a high energy level between a valence band and a conduction band of MgO, the energy required in the generation of the secondary electron decreases. Accordingly, the F and F+ centers included in the energy level of Mg facilitate the emission of the secondary electron.

The MgO protective layer comprising the F and F+ centers can be applied to not only the surface discharge type AC plasma display panel of FIG. 1 but also various kinds of plasma display panels comprising a protective layer.

In the plasma display panel according to the embodiment of the present invention, the MgO protective layer comprises the F and F+ centers such that the secondary electron emission coefficient of the MgO protective layer is high. Therefore, it is possible to generate the plasma discharge at the low voltage, and the brightness and the discharge efficiency of the plasma display panel can be improved.

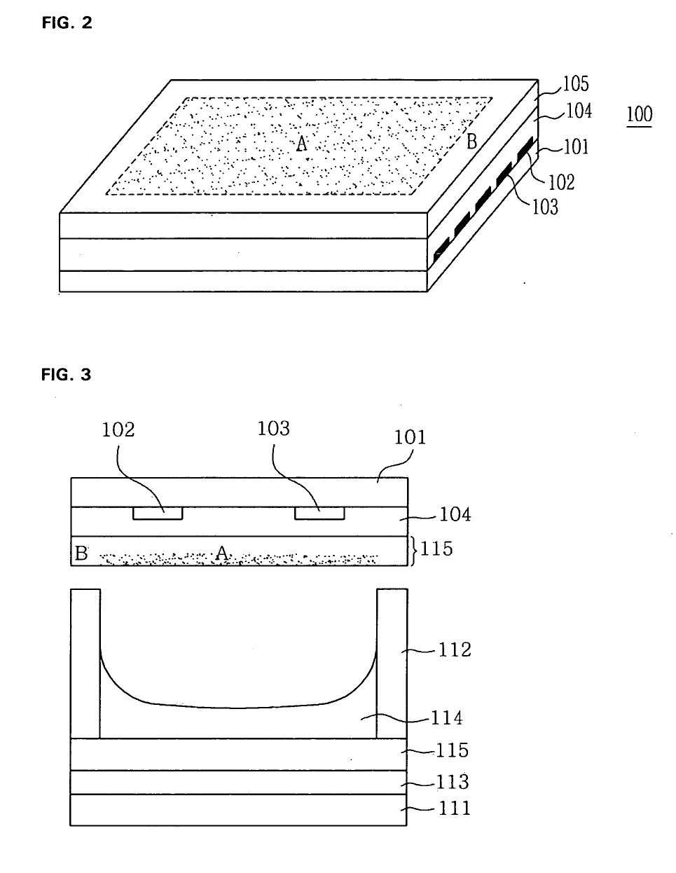

FIG. 2 illustrates a distribution range of F and F+ centers of a protective layer formed on a front panel of the plasma display panel according to the embodiment of the present invention.

As illustrated in FIG. 2, the front panel 100 may be divided into an effective region and an ineffective region. The division of the effective region and the ineffective region may be determined whether an image is or not displayed, or whether the phosphor is or not formed in the discharge cell partitioned by the barrier rib.

The protective layer comprises a first protective region A and a second protective region B. In such a case, the number of F-centers and the number of F+ centers in the first protective region A corresponding to the effective region are more than the number of F-centers and the number of F+ centers in the second protective region B corresponding to the ineffective region.

FIG. 3 illustrates the distribution of the number of F-centers and the number of F+ centers in a portion of a protective layer corresponding to a discharge cell in the plasma display panel according to the embodiment of the present invention. As illustrated in FIG. 3, the number of F-centers and the number of F+ centers in the first protective region A corresponding to the discharge cell partitioned by the barrier rib 112 are more than the number of F-centers and the number of F+ centers in the second protective region B corresponding to the remaining region except the discharge cell.

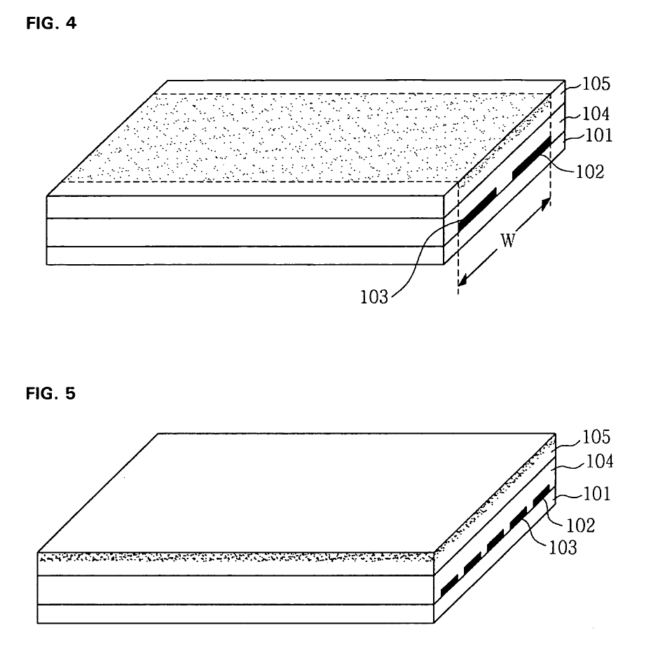

FIG. 4 illustrates the distribution of the number of F-centers and the number of F+centers in the protective layer corresponding to a maintenance electrode pair including a scan electrode and a sustain electrode in the plasma display panel according to the embodiment of the present invention. As illustrated in FIG. 4, the number of F-centers and the number of F+ centers in the first protective region A corresponding to a discharge gap W formed by the maintenance electrode pair are more than the number of F-centers and the number of F+ centers in the second protective region B corresponding to the remaining region except the discharge gap W.

In such a case, the discharge gap W is the largest distance between an end of the scan electrode 102 and an end of the sustain electrode 103.

Further, the F and F+ centers in the first protective region A corresponding to the discharge gap W may be differently distributed. For example, the number of F-centers and the number of F+ centers in a portion of the protective layer corresponding to the scan electrode 102 and the sustain electrode 103 may be more than the number of F-centers and the number of F+ centers in a portion of the protective layer corresponding to the remaining portion except a portion corresponding to each of the scan electrode 102 and the sustain electrode 103 from the discharge gap W.

FIG. 5 illustrates the distribution of the F and F+ centers in a total thickness of the protective layer in the plasma display panel according to the embodiment of the present invention. The F and F+ centers are formed within 3/10 of the total thickness of the protective layer. More specifically, when the total thickness of the protective layer ranges from an upper part to a lower part of the protective layer, the F and F+ centers are located within 3/10 of the total thickness of the protective layer from the upper part of the protective layer.

The following is a detailed description of a method for forming the F and F+ centers formed inside the protective layer of the plasma display panel.

First, MgO is deposited on the upper part of the upper dielectric layer 104 of the plasma display panel of FIG. 1 to form the MgO protective layer 105.

In such a case, the MgO protective layer 105 is formed by vacuum depositing MgO on the upper part of the upper dielectric layer 104 using an E-beam vacuum evaporation method. It is proper that a temperature of the front substrate 101 is 200° C., a degree of vacuum is 2×10⁻⁶ torr, and a rate of deposition ranges from 10 nm/min to 20 nm/min. Although a thin film is formed by the same E-beam vacuum evaporation method, the pollution of the thin film increases in a substrate of a low temperature in accordance with a scanning tunneling microscope (STM). Further, when a temperature of the substrate is high, the diffusion of MgO increases such that the combination of MgO is good. Accordingly, it is observed that a lump of the deposited MgO is large.

The MgO protective layer may be formed using a sputtering method. When forming the MgO protective layer by the sputtering method, since it is possible to deposit MgO on the upper dielectric layer 104 of the vertically set front substrate 101, the large area of the upper dielectric layer 104 can be deposited.

It is preferable that MgO is deposited on the upper dielectric layer 104 in an oxygen atmosphere of about 3×10⁻⁵ torr to about 1.3×10⁴ torr. The deposition of MgO in the excessive oxygen atmosphere is advantageous to form the F and F+ centers.

In the embodiment of the present invention, the MgO protective layer was formed using the E-beam vacuum evaporation method. However, the MgO protective layer may be formed using a thick film printing method.

Subsequently, the F and F+ centers may be formed in the MgO protective layer 105 formed on the upper part of the upper dielectric layer 104 using several methods.

After ions are implanted into the MgO protective layer 105, an E-beam is irradiated.

Ions to be implanted are accelerated using an electric field to have high kinetic energy, and then the accelerated ions collide with the surface of the MgO protective layer, thereby implanting the ions on the surface of a target material. The ions to be implanted have an energy of several tens to several hundreds of keV and collide with the surface of the MgO protective layer. The collided ions are implanted up to a depth of several of nm to several hundreds of nm from the surface of the MgO protective layer.

The implanted ions collide with lattice atom such that the lattice defect is formed inside the target material by a recoil process.

The ion implantation can effectively form the lattice defect on the surface of the MgO protective layer without affecting characteristics of the MgO protective layer. Further, the ion implantation can control the density and the depth of the lattice defect by adjusting an ion acceleration voltage and the amount of material to be implanted.

Since the ion implantation is a non-equilibrium thermodynamics process, the ion implantation is not limited to a thermodynamics characteristic such as solubility, diffusion. Accordingly, a surface layer having a new physical property can be formed.

More specifically, an ion source within a vacuum chamber is ionized by plasma, and then only desirous ions are accelerated, thereby scanning an ion beam on the target material.

The implanted ion may use silicon, nitrogen, sulfur or phosphor, and the like.

If the lattice defect is formed after the ion implantation, an electron beam is incident on the MgO protective layer for several seconds to several minutes. At this time, the electron is captured into the lattice defect such that the F and F+ centers are formed.

Another implementation for forming the F and F+ centers on the MgO protective layer may comprise an irradiation method of ultraviolet rays, an irradiation method of X-rays, an irradiation method of an electron beam, and the like. Further, another implementation may further comprise a method for irradiating all of the ultraviolet rays, the X-rays and the electron beam.

Since the secondary electron emission coefficient of the MgO protective layer thus manufactured is greatly improved, the discharge voltage is lowered.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a maintenance electrode pair formed on an upper part of a front panel;
a dielectric layer for covering the maintenance electrode pair;
a protective layer which comprises F center and F+ center and is formed on an upper part of the dielectric layer; and
a rear panel separated from the front panel by a given distance.

2. The plasma display panel of claim 1, wherein the front panel is divided into an effective region and a ineffective region, and
the number of F-centers and the number of F+ centers in a first protective region of the protective layer corresponding to the effective region are more than the number of F-centers and the number of F+ centers in a second protective region of the protective layer corresponding to the ineffective region.

3. The plasma display panel of claim 1, wherein the rear panel comprises a barrier rib for forming a discharge cell, and
the number of F-centers and the number of F+ centers in a first protective region of the protective layer corresponding to the discharge cell are more than the number of F− centers and the number of F+ centers in a second protective region of the protective layer corresponding to the remaining region except the discharge cell.

4. The plasma display panel of claim 1, wherein the number of F-centers and the number of F+ centers in a first protective region of the protective layer corresponding to a discharge gap formed by the maintenance electrode pair are more than the number of F-centers and the number of F+ centers in a second protective region of the protective layer corresponding to the remaining region except the discharge gap.

5. The plasma display panel of claim 4, wherein the discharge gap is the largest distance between ends of the maintenance electrode pair in one discharge region.

6. The plasma display panel of claim 1, wherein the F and F+ centers are formed within 3/10 of the total thickness of the protective layer.

7. The plasma display panel of claim 1, wherein the protective layer is formed of magnesium oxide (MgO).
